(19) United States
(12) Patent Application Publication
(10) Pub. No.: US 2016/0191382 A1
(43) Pub. Date: Jun. 30, 2016

(54) METHOD FOR TRANSMITTING SMALL DATA PACKET, AND DEVICE

(71) Applicant: Huawei Technologies Co., Ltd., Shenzhen (CN)

(72) Inventors: Yali Guo, Shenzhen (CN); Wanqiang Zhang, Beijing (CN)

(21) Appl. No.: 15/060,319

(22) Filed: Mar. 3, 2016

Related U.S. Application Data
(63) Continuation of application No. PCT/CN2013/082916, filed on Sep. 4, 2013.

(51) Int. Cl. H04L 12/741; H04W 4/00; H04W 72/04

(52) U.S. Cl. CPC H04L 45/74; H04W 72/042; H04W 4/005

(57) ABSTRACT

The present invention provides a method for transmitting a small data packet, and a device. The method includes: receiving, by a data transmission device, small data packet indication information sent by a gateway; and if the data transmission device determines, according to the small data packet indication information, that a to-be-sent data packet is a small data packet, transmitting, by the data transmission device, the small data packet in a control plane transmission manner. The present invention can ensure that a data transmission device accurately determines a small data packet, and avoid a network signaling increase caused by a determining error, thereby reducing a network load.

### CROSS-REFERENCE TO RELATED APPLICATIONS

This application is a continuation of International Application No. PCT/CN2013/082916, filed on Sep. 4, 2013, which is hereby incorporated by reference in its entirety.

### TECHNICAL FIELD

The present invention relates to communications technologies, and in particular, to a method for transmitting a small data packet, and a device.

### BACKGROUND

In the prior art, a terminal is connected to an application server by using a mobile communications network, and executes an application, such as remote monitoring or mobile payment, by interacting with the application server, An architecture of the mobile communications network is as follows: For example, the terminal is connected to a mobility management entity of a core network by using an evolved NodeB (eNodeB), then is connected to a serving gateway by using the mobility management entity, then is connected to a packet data network gateway by using the serving gateway, and finally is connected to the application server by using the packet data network gateway. Alternatively, the terminal is connected to a mobility management entity, and the mobility management entity is connected to a service interaction function entity, and then is connected to the application server by using the service interaction function entity.

For a mobile communications network with any architecture, a data packet in the uplink of a terminal may be a data packet having a small data volume, which is referred to as a small data packet, where the data volume is only several bytes. The terminal may add the small data packet to a non-access stratum (NAS) message and send the non-access stratum message to a mobility management entity, without needing to transmit the small data packet by establishing a bearer. However, a current small data packet is determined by the terminal, and for some malicious terminals, the terminals may directly transmit, by using the NAS message, a large data packet that should have been sent by using a common bearer, or divide a large data packet into multiple small data packets, and send the small data packets to the mobility management entity by using the NAS message. Therefore, signaling of the mobility management entity is congested and a network load is relatively heavy.

There are also some cases in which network signaling is congested and a network load is increased. For example, in downlink data transmission, a serving gateway may inaccurately determine a type of a data packet due to a network transmission factor, determine that a data packet that is not a small data packet is a small data packet, and transmit the small data packet in a control plane transmission manner, such as by using an NAS message; for example, transmit the small data packet by using a downlink data notification message. When subsequently finding that the data packet is not a small data packet, the serving gateway further needs to create a bearer for transmission, which also increases a network signaling load.

### SUMMARY

The present invention provides a method for transmitting a small data packet, and a device, so as to ensure that a small data packet is accurately determined, and reduce a network load.

According to a first aspect, a method for transmitting a small data packet is provided, including:

receiving, by a data transmission device, small data packet indication information sent by a gateway; and

if the data transmission device determines, according to the small data packet indication information, that a to-be-sent data packet is a small data packet, transmitting, by the data transmission device, the small data packet in a control plane transmission manner.

With reference to the first aspect, in a first possible implementation manner, the data transmission device is user equipment UE; and the transmitting the small data packet in a control plane transmission manner is specifically: sending, by the UE, the small data packet to a mobility management entity by using a non-access stratum NAS message.

With reference to the first possible implementation manner of the first aspect, in a second possible implementation manner, the receiving, by a data transmission device, small data packet indication information sent by a gateway includes: receiving, by the UE, a traffic filter template TFT sent by a packet data network gateway P-GW, where the TFT includes a data packet filter corresponding to a small data packet, and small data packet indication information is set for the data packet filter; and the determining, by the data transmission device according to the small data packet indication information, that a to-be-sent data packet is a small data packet includes: searching, by the UE, for a data packet filter corresponding to the to-be-sent data packet, and if the small data packet indication information is set for the data packet filter, determining that the to-be-sent data packet is a small data packet.

With reference to the first possible implementation manner of the first aspect, in a third possible implementation manner, the receiving, by a data transmission device, small data packet indication information sent by a gateway includes: receiving, by the UE, a traffic filter template TFT and small data packet indication information that are sent by a P-GW, where the TFT includes only a data packet filter corresponding to a small data packet, and the small data packet indication information is used for indicating that a bearer corresponding to the TFT is a bearer specially used for transmitting a small data packet; and the determining, by the data transmission device according to the small data packet indication information, that a to-be-sent data packet is a small data packet includes: searching, by the UE, for a data packet filter corresponding to the to-be-sent data packet, checking whether a bearer corresponding to a TFT using the data packet filter is a bearer specially used for transmitting a small data packet, and if yes, determining that the to-be-sent data packet is a small data packet.

With reference to the first possible implementation manner of the first aspect, in a fourth possible implementation manner, the receiving, by a data transmission device, small data packet indication information sent by a gateway includes: receiving, by the UE, a data packet filter, which is sent by a machine type communications-interworking function entity MTC-IWF, of a small data packet, where the data packet filter has small data packet indication information; and the determining, by the data transmission device according to the small data packet indication information, that a to-be-sent data packet is a small data packet includes: searching, by the UE, for a data packet filter corresponding to the to-be-sent data packet, and if the data packet filter has the small data packet indication information, determining that the to-be-sent data packet is a small data packet.

With reference to any one of the second possible implementation manner to the fourth possible implementation manner of the first aspect, in a fifth possible implementation manner, the small data packet indication information includes a small data volume identifier extended in a data packet filter, or a filter name corresponding to a data packet filter of a small data packet.

With reference to the first aspect, in a sixth possible implementation manner, the data transmission device is a serving gateway S-GW; and the transmitting the small data packet in a control plane transmission manner is specifically: sending, by the S-GW, the small data packet to a mobility management entity by using a downlink data notification message.

With reference to the sixth possible implementation manner of the first aspect, in a seventh possible implementation manner, the receiving, by a data transmission device, small data packet indication information sent by a gateway includes: receiving, by the S-GW, a to-be-sent data packet transmitted by a P-GW, where small data packet indication information is set for a GTP-U header of the data packet; and the determining, by the data transmission device according to the small data packet indication information, that a to-be-sent data packet is a small data packet includes: determining, by the S-GW according to the small data packet indication information, that the to-be-sent data packet is a small data packet.

According to a second aspect, a method for transmitting a small data packet is provided, including:

setting, by a gateway, small data packet indication information; and

sending, by the gateway, the small data packet indication information to a data transmission device, so that when determining, according to the small data packet indication information, that a to-be-sent data packet is a small data packet, the data transmission device transmits the small data packet in a control plane transmission manner.

With reference to the second aspect, in a first possible implementation manner, the gateway is a packet data network gateway P-GW, and the data transmission device is user equipment UE.

With reference to the first possible implementation manner of the second aspect, in a second possible implementation manner, the setting, by a gateway, small data packet indication information includes: adding, by the P-GW, a data packet filter corresponding to a small data packet to a traffic filter template TFT, and setting small data packet indication information for the data packet filter.

With reference to the first possible implementation manner of the second aspect, in a third possible implementation manner, the setting, by a gateway, small data packet indication information includes: putting, by the P-GW, data packet filters of small data packets into a same traffic filter template TFT, and setting small data packet indication information, where the small data packet indication information is used for indicating that a bearer corresponding to the TFT is a bearer specially used for transmitting a small data packet.

With reference to the third possible implementation manner of the second aspect, in a fourth possible implementation manner, the sending, by the gateway, the small data packet indication information to a data transmission device includes: adding, by the P-GW, the traffic filter template TFT and the small data packet indication information to a create or modify bearer signaling request.

With reference to any one of the second possible implementation manner to the fourth possible implementation manner of the second aspect, in a fifth possible implementation manner, before the setting, by a gateway, small data packet indication information, the method further includes: receiving, by the P-GW, a PCC rule sent by a PCRF, where the PCC rule includes a data packet filter corresponding to a small data packet and small data packet indication information corresponding to the data packet filter, and the small data packet indication information is used by the P-GW to accordingly set the small data packet indication information; or acquiring, by the P-GW, a local configuration policy, where the local configuration policy is used by the P-GW for setting the small data packet indication information.

With reference to the second aspect, in a sixth possible implementation manner, the gateway is a machine type communications-interworking function entity MTC-IWF, and the data transmission device is user equipment UE.

With reference to the sixth possible implementation manner of the second aspect, in a seventh possible implementation manner, the setting, by a gateway, small data packet indication information includes: acquiring, by the MTC-IWF, a data packet filter corresponding to a small data packet, where the data packet filter has small data packet indication information, and the small data packet indication information includes a small data volume identifier extended in a data packet filter, or a filter name corresponding to a data packet filter of a small data packet.

With reference to the seventh possible implementation manner of the second aspect, in an eighth possible implementation manner, the method further includes: adjusting, by the MTC-IWF, the data packet filter according to a carrier policy.

With reference to the second aspect, in a ninth possible implementation manner, the gateway is a packet data network gateway P-GW, and the data transmission device is a serving gateway S-GW.

With reference to the ninth possible implementation manner of the second aspect, in a tenth possible implementation manner, the setting, by a gateway, small data packet indication information includes: setting, by the P-GW, the small data packet indication information in a GTP-U header of the small data packet sent to the S-GW.

According to a third aspect, a data transmission device is provided, including:

a receiving unit, configured to receive small data packet indication information sent by a gateway;

a processing unit, configured to determine, according to the small data packet indication information received by the receiving unit, whether a to-be-sent data packet is a small data packet; and

a transmission unit, configured to: when the processing unit determines that the to-be-sent data packet is a small data packet, transmit the small data packet in a control plane transmission manner.

With reference to the third aspect, in a first possible implementation manner, the data transmission device is user equipment UE; and the transmission unit is specifically configured to send the small data packet to a mobility management entity by using a non-access stratum NAS message.

With reference to the first possible implementation manner of the third aspect, in a second possible implementation manner, the receiving unit is specifically configured to receive a traffic filter template TFT sent by a packet data network gateway P-GW, where the TFT includes a data packet filter corresponding to a small data packet, and small data packet indication information is set for the data packet filter; and the processing unit is specifically configured to search for a data packet filter corresponding to the to-be-sent data packet, and if the small data packet indication information is set for the data packet filter, determine that the to-be-sent data packet is a small data packet.

With reference to the first possible implementation manner of the third aspect, in a third possible implementation manner, the receiving unit is specifically configured to receive a traffic filter template TFT and small data packet indication information that are sent by a P-GW, where the TFT includes only a data packet filter corresponding to a small data packet, and the small data packet indication information is used for indicating that a bearer corresponding to the TFT is a bearer specially used for transmitting a small data packet; and the processing unit is specifically configured to: search for a data packet filter corresponding to the to-be-sent data packet, check whether a bearer corresponding to a TFT using the data packet filter is a bearer specially used for transmitting a small data packet, and if yes, determine that the to-be-sent data packet is a small data packet.

With reference to the first possible implementation manner of the third aspect, in a fourth possible implementation manner, the receiving unit is specifically configured to receive a data packet filter, which is sent by a machine type communications-interworking function entity MTC-IWF, of a small data packet, where the data packet filter has small data packet indication information; and the processing unit is specifically configured to search for a data packet filter corresponding to the to-be-sent data packet, and if the data packet filter has the small data packet indication information, determine that the to-be-sent data packet is a small data packet.

With reference to any one of the second possible implementation manner to the fourth possible implementation manner of the third aspect, in a fifth possible implementation manner, the small data packet indication information received by the receiving unit includes a small data volume identifier extended in a data packet filter, or a filter name corresponding to a data packet filter of a small data packet.

With reference to the third aspect, in a sixth possible implementation manner, the data transmission device is a serving gateway S-GW; and the transmission unit is specifically configured to send the small data packet to a mobility management entity by using a downlink data notification message.

With reference to the sixth possible implementation manner of the third aspect, in a seventh possible implementation manner, the receiving unit is specifically configured to receive a to-be-sent data packet transmitted by a P-GW, where the small data packet indication information is set for a header of the data packet; and the processing unit is specifically configured to determine, according to the small data packet indication information, that the to-be-sent data packet is a small data packet.

According to a fourth aspect, a gateway is provided, including:

a setting unit, configured to set small data packet indication information; and

a sending unit, configured to send the small data packet indication information to a data transmission device, so that when determining, according to the small data packet indication information, that a to-be-sent data packet is a small data packet, the data transmission device transmits the small data packet in a control plane transmission manner.

With reference to the fourth aspect, in a first possible implementation manner, the gateway is a packet data network gateway P-GW, and the data transmission device is user equipment UE.

With reference to the first possible implementation manner of the fourth aspect, in a second possible implementation manner, the setting unit is specifically configured to add a data packet filter corresponding to a small data packet to a traffic filter template TFT, and set small data packet indication information for the data packet filter.

With reference to the first possible implementation manner of the fourth aspect, in a third possible implementation manner, the setting unit is specifically configured to put data packet filters of small data packets into a same traffic filter template TFT, and set small data packet indication information, where the small data packet indication information is used for indicating that a bearer corresponding to the TFT is a bearer specially used for transmitting a small data packet.

With reference to the third possible implementation manner of the fourth aspect, in a fourth possible implementation manner, the sending unit is specifically configured to add the traffic filter template TFT and the small data packet indication information to a create or modify bearer signaling request.

With reference to any one of the second possible implementation manner to the fourth possible implementation manner of the fourth aspect, in a fifth possible implementation manner, the setting unit is further configured to: before the small data packet indication information is set, receive a PCC rule sent by a PCRF, where the PCC rule includes a data packet filter corresponding to a small data packet and small data packet indication information corresponding to the data packet filter, and the small data packet indication information is used by the P-GW to accordingly set the small data packet indication information; or the P-GW acquires a local configuration policy, where the local configuration policy is used by the P-GW for setting the small data packet indication information.

With reference to the fourth aspect, in a sixth possible implementation manner, the gateway is a machine type communications-interworking function entity MTC-IWF, and the data transmission device is user equipment UE.

With reference to the sixth possible implementation manner of the fourth aspect, in a seventh possible implementation manner, the setting unit is specifically configured to acquire a data packet filter corresponding to a small data packet, where the data packet filter has small data packet indication information, and the small data packet indication information includes a small data volume identifier extended in a data packet filter, or a filter name corresponding to a data packet filter of a small data packet.

With reference to the seventh possible implementation manner of the fourth aspect, in an eighth possible implementation manner, the setting unit is further configured to adjust the data packet filter according to a carrier policy.

With reference to the fourth aspect, in a ninth possible implementation manner, the gateway is a packet data network gateway P-GW, and the data transmission device is a serving gateway S-GW.

With reference to the ninth possible implementation manner of the fourth aspect, in a tenth possible implementation manner, the setting unit is specifically configured set the small data packet indication information in a header of the small data packet sent to the S-GW.

The method for transmitting a small data packet and the device that are provided by the present invention have the following technical effects: A data transmission device determines a small data packet by using small data packet indication information sent by a gateway, so that the small data packet is determined under control of a network, and the gateway can accurately know whether a data packet is a small data packet, instead of determining by the data transmission device whether a data packet is a small data packet. In this way, it can be ensured that a data transmission device accurately determines a small data packet, avoiding a network signaling increase caused by a determining error, thereby reducing a network load.

### BRIEF DESCRIPTION OF THE DRAWINGS

FIG. 1 is a network architectural diagram 1 of an embodiment of a method for transmitting a small data packet according to the present invention;

FIG. 2 is a network architectural diagram 2 of an embodiment of a method for transmitting a small data packet according to the present invention;

FIG. 3 is a schematic flowchart of an embodiment of a method for transmitting a small data packet according to the present invention;

FIG. 4 is a schematic flowchart of another embodiment of a method for transmitting a small data packet according to the present invention;

FIG. 5 is a schematic signaling diagram of still another embodiment of a method for transmitting a small data packet according to the present invention;

FIG. 6 is a schematic signaling diagram of still another embodiment of a method for transmitting a small data packet according to the present invention;

FIG. 7 is a schematic signaling diagram of still another embodiment of a method for transmitting a small data packet according to the present invention;

FIG. 8 is a schematic signaling diagram of still another embodiment of a method for transmitting a small data packet according to the present invention;

FIG. 9 is a schematic structural diagram of an embodiment of a data transmission device according to the present invention; and

FIG. 10 is a schematic structural diagram of an embodiment of a gateway according to the present invention.

### DETAILED DESCRIPTION

Embodiments of the present invention provide a method for transmitting a small data packet. The small data packet refers to a data packet having a small data volume, such as information having a data volume of only several bytes. The method may be used in scenarios in which a user equipment (UE) terminal initiates an MO (Mobile Originate) small data packet, and a terminal receives an MT (Mobile Terminated) small data packet. The method in the embodiments of the present invention, for example, may be applied to machine type communications (MTC), for example, user equipment transmits a small data packet to a peer end by using a mobility management entity (MME), or a peer end transmits a small data packet to an MME by using a serving gateway (S-GW), and the MME sends the small data packet to user equipment, and the like. The method in the embodiments of the present invention is also applicable to a common communications scenario except the MTC; moreover, the method in the embodiments of the present invention is applicable to multiple networks, such as a Long Time Evolution (LTE) network, a Universal Mobile Telecommunications System (UMTS) network, and a Global System for Mobile Communications (GSM) network. In the UMTS network, the MME may be replaced with a serving GPRS support node (SGSN, which may also be referred to as a mobility management entity); in the GSM network, the MME may be replaced with a mobile switching center (MSC).

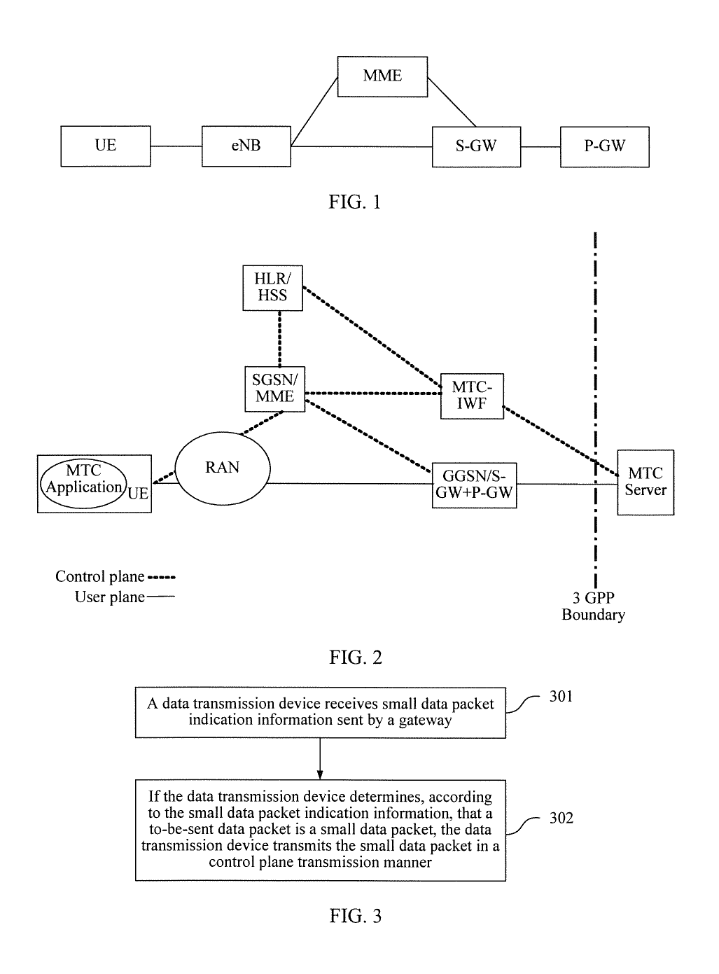

In the following embodiments, descriptions are given by using a method for transmitting a small data packet in an LTE system as example. However, it can be understood that, the method of the present invention is also applicable to other systems or other scenarios, such as the various scenarios described above. First, a system architecture used in the method is provided. As shown in FIG. 1, FIG. 1 is a network architectural diagram 1 of an embodiment of a method for transmitting a small data packet according to the present invention. UE is connected to an MME/S-GW of a core network by using an eNodeB, and is connected to a P-GW by using the S-GW. Alternatively, reference may be made to FIG. 2, and FIG. 2 is a network architectural diagram 2 of an embodiment of a method for transmitting a small data packet according to the present invention. To enable an application service platform MTC server to send a small data packet to UE by using a mobile communications network, a service interaction function entity MTC-IWF is set, and for an uplink small data packet, the UE sends the small data packet to an MME, then the MME adds the received small data packet to a control plane message and sends the control plane message to the MTC-IWF, and the MTC-IWF adds the control plane message to control plane signaling and sends the control plane signaling to the MTC server. FIG. 2 further shows a transmission path in FIG. 1, that is, an IP data bearer is still used for small data packet interaction between UE and an MTC server. The UE sends a small data packet to an MME, the MME sends the received small data packet to an S-GW by using a GTP-C control plane or a GTP-U user plane, then, the S-GW sends the received small data packet to a P-GW by using a corresponding data bearer, and the P-GW then IP routes the small data packet to the MTC server.

The method for transmitting a small data packet of the present invention is described by using the architectures in FIG. 1 and FIG. 2 as an example.

### Embodiment 1

FIG. 3 is a schematic flowchart of an embodiment of a method for transmitting a small data packet according to the present invention, and the method in this embodiment may be performed by a data transmission device. As shown in FIG. 3, the method may include:

301: The data transmission device receives small data packet indication information sent by a gateway.

The data transmission device may be, for example, UE or an S-GW. These devices may transmit a small data packet to a mobility management entity, and therefore, may be referred to as data transmission devices. The gateway may be, for example, a P-GW or an MTC-IWF. These devices may generate small data packet indication information and send the small data packet indication information to the data transmission device, so that the data transmission device accordingly determines whether a data packet is a small data packet.

The small data packet indication information may also be in various forms. For example, the indication information may be small data packet indication information extendedly set in a data packet filter corresponding to a data packet, and if the data transmission device searches for a data packet filter corresponding to the data packet, and the data packet filter has the small data packet indication information, it may be determined that the data packet is a small data packet. Alternatively, the indication information may be used for indicating that a bearer corresponding to a traffic filter template (TFT) using the data packet filter is a bearer specially used for transmitting a small data packet, or may be used for determining that the data packet is a small data packet. Alternatively, the indication information may be a particular filter name, and if the data transmission device searches for a data packet filter corresponding to the data packet, and the filter has the particular filter name, it may be accordingly determined that the data packet is a small data packet. Alternatively, the indication information may be small data packet indication information added by a P-GW to a GTP-U header of the data packet. Certainly, in a specific implementation, the small data packet indication information may be set in another form, which is not limited in this embodiment of the present invention, as long as it can be accordingly determined that the data packet is a small data packet.

302: If the data transmission device determines, according to the small data packet indication information, that a to-be-sent data packet is a small data packet, the data transmission device transmits the small data packet in a control plane transmission manner.

In this embodiment, the data transmission device transmits the small data packet to a mobility management entity in a control plane transmission manner (certainly, persons skilled in the art may understand that the mobility management entity is not a final destination device to which the data packet is transmitted) , and there may also be various manners. For example, the control plane transmission manner may be an NAS message, and when determining that a data packet is a small data packet, UE may send the small data packet to an MME by using the NAS message. For another example, the control plane transmission manner may be a downlink data notification message sent by an S-GW to an MME.

In this embodiment, a data transmission device determines, according to small data packet indication information sent by a gateway, whether a data packet is a small data packet, and if the data transmission device determines that the data packet is a small data packet, the data transmission device transmits the data packet to a mobility management entity in a control plane transmission manner, for example, by using an NAS message. It should be noted that, the small data packet indication information is set by a gateway, for example, the small data packet indication information is set by a P-GW and sent by the P-GW to UE, and the gateway can accurately know whether a data packet is small data packet. For example, the P-GW sets the small data packet indication information according to a PCC rule delivered by a PCRF, where the PCC rule includes a data packet filter corresponding to a small data packet, and small data packet indication information of the data packet filter, and the P-GW accordingly determines that a data packet filter is a filter of a small data packet, and extendedly sets small data packet indication information for the filter; or the P-GW has already predetermined a type of data packet filter that is a filter of a small data packet, and therefore, can set small data packet indication information for the filter. Therefore, a data transmission device determines, according to small data packet indication information sent by a gateway, whether a data packet is a small data packet, so that a small data packet can be accurately determined, avoiding a case in the prior art of inaccurate determining or malicious transmission caused due to determining by the data transmission device, thereby reducing a network signaling load.

### Embodiment 2

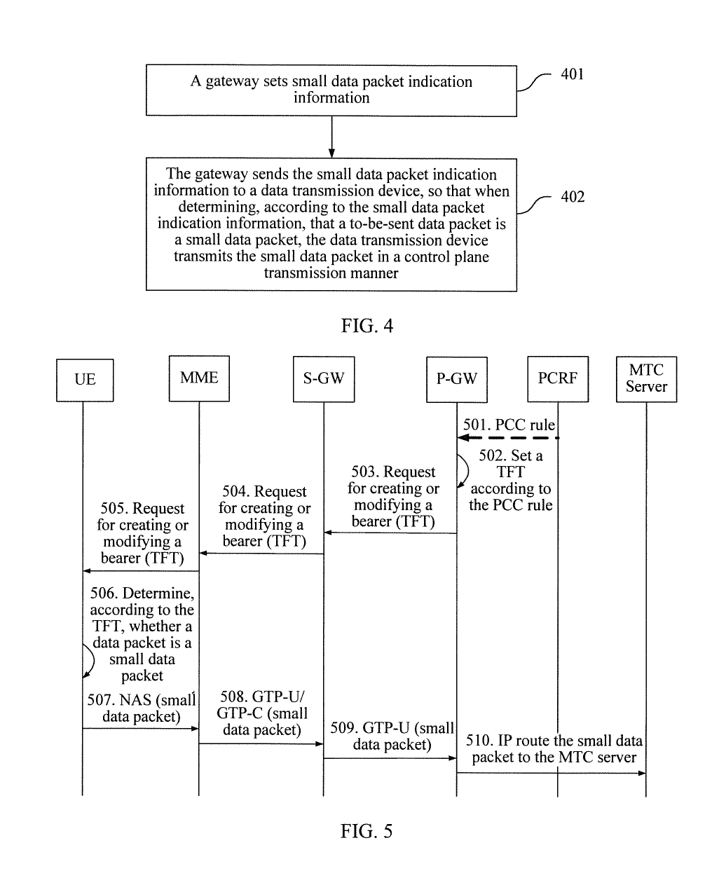

FIG. 4 is a schematic flowchart of another embodiment of a method for transmitting a small data packet according to the present invention, and the method in this embodiment may be performed by a gateway of a core network. As shown in FIG. 4, the method may include:

401: The gateway sets small data packet indication information.

The gateway is, for example, a P-GW or an MTC-IWF. The gateway may also set the small data packet indication information in multiple types of manners. For example, the P-GW may set the small data packet indication information according to a PCC rule delivered by a PCRF, where the PCC rule includes a data packet filter corresponding to a small data packet, and small data packet indication information of the data packet filter, and the P-GW accordingly determines that a data packet filter is a filter of a small data packet, and extendedly sets small data packet indication information for the filter; or the P-GW has already predetermined a type of data packet filter that is a filter of a small data packet, and therefore, can set small data packet indication information for the filter. Alternatively, the MTC-IWF receives a data packet filter of a small data packet from an MTC server.

It should be noted that, the gateway can accurately know whether a data packet is a small data packet, for example, in the foregoing description, when the P-GW predetermines a type of data packet filter that is a filter of a small data packet, this case may be: for example, it is specified in advance that all data packets sent to an IP address (a data packet filter includes an IP quintet, for example, a source IP address and a destination IP address) are small data packets, the P-GW checks the data packet filter, and if the destination IP address included in the data packet filter is the IP address, the P-GW can determine that the data packet filter is a data packet filter of a small data packet, and sets small data packet indication information for the data packet filter. A PCRF and an MTC server these devices can also accurately know whether a data packet filter is a filter of a small data packet, and when sending a data packet filter to a P-GW or an MTC-IWF, these devices set an identifier for indicating that the data packet filter is a data packet filter of a small data packet. In this way, the P-GW or the MTC-IWF can also accurately know a data packet filter of a small data packet.

402: The gateway sends the small data packet indication information to a data transmission device, so that when determining, according to the small data packet indication information, that a to-be-sent data packet is a small data packet, the data transmission device transmits the small data packet in a control plane transmission manner.

In this step, the sending, by the gateway, the small data packet indication information to a data transmission device may be: sending, by the gateway, the small data packet indication information by using at least one intermediate device. For example, the P-GW sends, by using an S-GW and an MME, a TFT including a data packet filter carrying small data packet indication information to UE.

According to the method for transmitting a small data packet in this embodiment, a data transmission device determines, according to small data packet indication information sent by a gateway, whether a data packet is a small data packet and only if it is determined that the data packet is a small data packet, the data packet is transmitted to a mobility management entity in a control plane transmission manner, for example, by using an NAS message, so that a small data packet can be accurately determined, avoiding a case in the prior art of inaccurate determining or malicious transmission caused due to determining by the data transmission device, thereby reducing a network signaling load.

Several feasible methods for transmitting a small data packet are described below by using several specific examples.

### Embodiment 3

In this embodiment, a small data packet and a common data packet may be transmitted in a core network by using a same bearer, and a P-GW uses a same bearer to transmit data packets having a same QoS requirement, whether the data packet is a small data packet or a common data packet. FIG. 5 is a schematic signaling diagram of still another embodiment of a method for transmitting a small data packet according to the present invention. As shown in FIG. 5, the method may include:

501: A PCRF sends a PCC rule to a P-GW.

Step 501 is an optional step. The PCC rule includes at least one data packet filter and a QoS requirement corresponding to the data packet filter; moreover, for a data packet filter of a small data packet, the PCC rule further includes small data packet indication information corresponding to the data packet filter of the small data packet.

502: The P-GW sets a TFT according to the PCC rule.

The P-GW is configured to set a TFT, and the TFT includes at least one data packet filter, and specific content of each data packet filter is an IP quintet, that is, a source IP address, a destination IP address, a source port number, a destination port number, and an upper-layer protocol number. In this embodiment, the P-GW extends the data packet filter. For a data packet having a small data volume, a piece of small data packet indication information is extended in a data packet filter of the data packet, indicating that data meeting the data packet filter is a small data packet.

In this embodiment, a rule for setting the TFT by the P-GW is that, data streams having a same QoS requirement are transmitted by using a same bearer, that is, data packet filters having a same QoS requirement are put into a same TFT. Therefore, the P-GW may put, according to a QoS requirement included in the PCC rule received by the P-GW, data packet filters having a QoS requirement into a same TFT. Moreover, if the data packet filter in the PCC rule has small data packet indication information, it indicates that the data packet filter is a filter of a small data packet, and the P-GW accordingly sets small data packet indication information for the data packet filter put into the TFT, and UE may accordingly determine a small data packet.

Optionally, in addition to setting the foregoing small data packet indication information according to the PCC rule, the P-GW in this embodiment may further set the foregoing small data packet indication information according to a local configuration policy, where the local configuration policy is used by the P-GW to accordingly set the small data packet indication information. For example, it may be preconfigured in the P-GW that a data packet whose destination IP address is an A address is determined as a small data packet, that is, if a destination IP address in an IP quintet of a data packet filter is the A address, it indicates that the data packet filter is a data packet filter of a small data packet. The P-GW sets small data packet indication information for the data packet filter of the small data packet according to the preconfigured policy.

503: The P-GW sends a create or modify bearer signaling request to an S-GW, and adds the TFT to the request.

When determining to create or modify a bearer, the P-GW sends a create or modify bearer signaling request (Create/Modify bearer) to the S-GW, and adds the TFT set in 502 to the request.

504: The S-GW sends the create or modify bearer signaling request that carries the TFT to an MME.

505: The MME sends the create or modify bearer signaling request that carries the TFT to UE.

In this way, the P-GW sends, by using the S-GW and the MME, the TFT set by the P-GW in 502 to the UE. As described above, the TFT includes data packet filters having a same QoS requirement, and for a data packet filter of a small data packet, the filter further has small data packet indication information. In this way, the P-GW sends the small data packet indication information to the UE.

506: The UE determines, according to the small data packet indication information in the TFT, whether a to-be-sent data packet is a small data packet.

When the UE needs to send an uplink data packet, the uplink data packet may be referred to as a to-be-sent data packet; and the UE performs determining by using the received TFT. Specifically, the UE searches for a data packet filter, in a TFT, that corresponds to the to-be-sent data packet, and if the data packet filter corresponding to the to-be-sent data packet carries small data packet indication information, the UE may determine that the to-be-sent data packet is a small data packet, and the UE continues to perform 507.

In this step, if the UE searches for a data packet filter, in a TFT, that corresponds to the to-be-sent data packet, and the data packet filter corresponding to the to-be-sent data packet does not carry small data packet indication information, it indicates that the to-be-sent data packet is not a small data packet, and the UE sends the data packet in a common bearer manner.

507: The UE sends a small data packet to the MME by using an NAS message.

When sending the NAS message to the MME, the UE directly adds the small data packet to the NAS message for transmission, and transmits a determined bearer ID and the small data packet to the MME together by using the NAS message, where the bearer ID is an identifier of a bear that needs to be created or modified and that is indicated by the request, which is received by the UE, for creating or modifying a bearer.

508: The MME sends the small data packet to the SGW by using a control plane GTP-C message or a GTP-U data plane bearer.

In this step, the MME sends the received small data packet and the bearer ID to the S-GW together.

509: The S-GW transmits the small data packet to the P-GW.

In this step, the S-GW may transmit the small data packet to the P-GW by using a bearer corresponding to the bearer ID.

510: The P-GW routes (IP routing) the small data packet to an MTC server.

### Embodiment 4

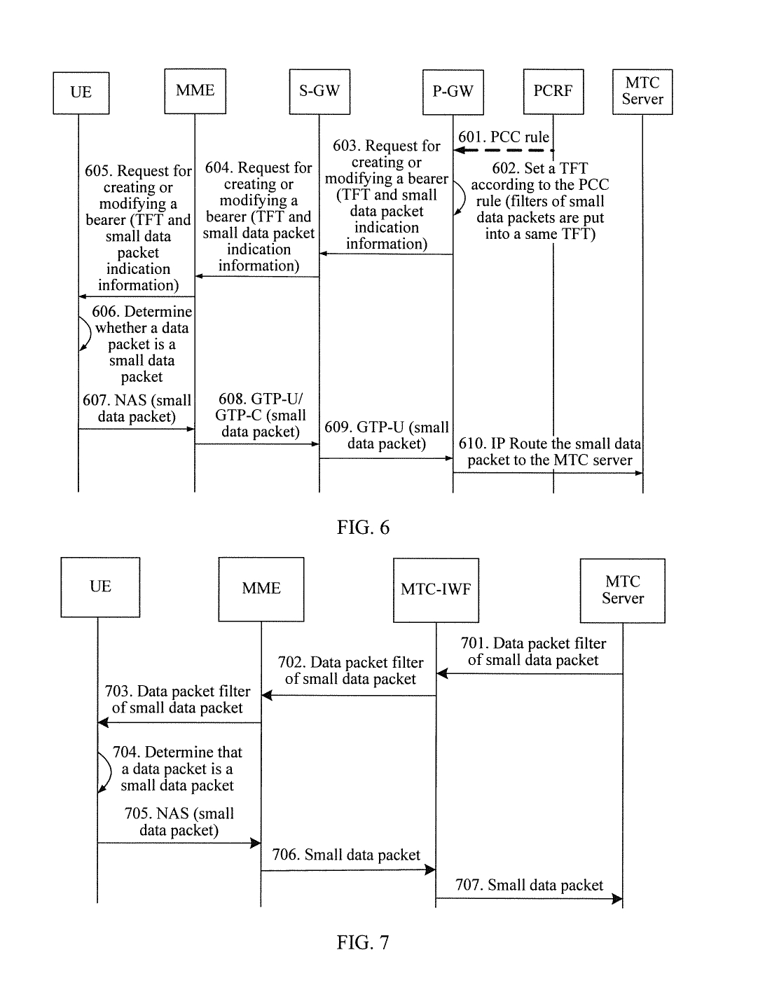

In this embodiment, a small data packet may be transmitted in a core network by using a dedicated bearer, and a P-GW uses one or more bearers specially used for transmitting a small data packet. FIG. 6 is a schematic signaling diagram of still another embodiment of a method for transmitting a small data packet according to the present invention. As shown in FIG. 6, the method may include:

601: A PCRF sends a PCC rule to a P-GW.

Step 601 is an optional step. The P-GW receives one or more PCC rules from the PCRF, and each PCC rule includes a data packet filter. For a data packet filter of a small data packet, the PCC rule further includes small data packet indication information corresponding to the data packet filter of the small data packet.

602: The P-GW sets a TFT according to the PCC rule.

The P-GW is configured to set a TFT, and the TFT includes at least one data packet filter, and specific content of each data packet filter is an IP quintet, that is, a source IP address, a destination IP address, a source port number, a destination port number, and an upper-layer protocol number.

In this embodiment, a rule for setting the TFT by the P-GW is that, data streams of small data packets are transmitted by using a same bearer, that is, data packet filters of the small data packets are put into a same TFT. Therefore, the P-GW may put, according to small data packet indication information corresponding to a data packet filter included in the PCC rule received by the P-GW, data packet filters having small data packet indication information into a same TFT, that is, the TFT includes only a data packet filter corresponding to a small data packet.

Similarly, the P-GW in this embodiment may further set the foregoing TFT according to a local configuration policy, and a specific method is similar to that in Embodiment 3, which is not described in detail again.

603: The P-GW sends a create or modify bearer signaling request to an S-GW, and adds the traffic filter template TFT and small data packet indication information to the request, where the small data packet indication information is used for indicating that a bearer corresponding to the TFT is a bearer specially used for transmitting a small data packet.

When determining to create or modify a bearer, the P-GW sends a create or modify bearer signaling request (Create/Modify bearer) to the S-GW, and adds the TFT set in 602 to the request. In this embodiment, the P-GW further adds small data packet indication information to the create or modify bearer signaling request, indicating that a bearer to be created or modified is a bearer specially used for transmitting a small data packet, that is, a bearer corresponding to the TFT is a bearer specially used for transmitting a small data packet.

604: The S-GW sends the create or modify bearer signaling request that carries the TFT and the small data packet indication information to an MME.

605: The MME sends the create or modify bearer signaling request that carries the TFT and the small data packet indication information to UE.

In this way, the P-GW sends, by using the S-GW and the MME, the TFT set by the P-GW in 602 to the UE, and also sends, to UE, small data packet indication information that is used for indicating a dedicated bearer. As described above, the TFT includes only a data packet filter of a small data packet, and the P-GW further sends small data packet indication information to the UE, indicating that a bearer corresponding to the TFT is a bearer specially used for transmitting a small data packet.

606: The UE determines whether a to-be-sent data packet is a small data packet.

When the UE needs to send an uplink data packet, the uplink data packet may be referred to as a to-be-sent data packet; and the UE performs determining by using the received TFT. Specifically, the UE searches for a data packet filter, in a TFT, that corresponds to the to-be-sent data packet, and checks whether a bearer corresponding to the TFT using the data packet filter is a bearer specially used for transmitting a small data packet, and if yes, the UE continues to perform 607.

In this step, if the UE searches for a data packet filter, in a TFT, that corresponds to the to-be-sent data packet, and the bearer corresponding to the TFT using the data packet filter is not a bearer specially used for transmitting a small data packet, the UE sends the data packet in a common bearer manner.

607: The UE sends a small data packet to the MME by using an NAS message.

When sending the NAS message to the MME, the UE directly adds the small data packet to the NAS message for transmission. Optionally, if there are multiple bearers specially used for transmitting a small data packet, the UE transmits a bearer ID and a data packet together to the MME by using the NAS, where the bearer ID is an identifier of a bearer that needs to be created or modified and that is indicated by the request, which is received by the UE, for creating or modifying a bearer.

608: The MME sends the small data packet to the SGW by using a control plane GTP-C message or a GTP-U data plane bearer.

In this step, the MME sends the received small data packet and the bearer ID to the S-GW together.

609: The S-GW transmits the small data packet to the P-GW.

In this step, the S-GW may transmit the small data packet to the P-GW by using a bearer corresponding to the bearer ID.

610: The PGW routes (IP routing) the small data packet to an MTC server.

### Embodiment 5

In this embodiment, a small data packet may be transmitted in a core network by means of a control plane by using an MTC-IWF. FIG. 7 is a schematic signaling diagram of still another embodiment of a method for transmitting a small data packet according to the present invention. As shown in FIG. 7, the method may include:

701: An MTC server sends a data packet filter of a small data packet to an MTC-IWF.

Specific content of each data packet filter may be a quintet, that is, a source IP address, a destination IP address, a source port number, a destination port number, and an upper-layer protocol number. Certainly, the specific content may also be any other form in which a data stream may be filtered. Moreover, in this embodiment, small data packet indication information may be set for a data packet filter, where the small data packet indication information includes a small data volume identifier extended in a data packet filter, or a filter name corresponding to a data packet filter of a small data packet. The filter name is a name different from a filter name of a common data packet, so that UE can identify, according to the filter name, whether a corresponding data packet is a common data packet or a small data packet. Certainly, in a specific implementation, small data packet indication information in another embodiment may be set as a small data volume identifier extended in the data packet filter, or a filter name corresponding to a data packet filter of a small data packet, as described above.

702: The MTC-IWF sends the received data packet filter of the small data packet to an MME.

Optionally, in this step, the MTC-IWF may adjust, according to a carrier policy, the data packet filter received from the MTC server, for example, perform an authorized operation, such as addition, modification, aggregation, or rejection, on the data packet filter according to the carrier policy.

703: The MME sends the data packet filter of the small data packet to UE.

704: The UE determines, according to the received filter, whether a to-be-sent data packet is a small data packet.

As described above, for the data packet filter, received by the UE, of the small data packet, it may indicated, by using a filter name or a small data volume identifier, that the data packet filter is a data packet filter of a small data packet, and therefore, the filter name or the small data volume identifier is equivalent to small data packet indication information. According to the small data packet indication information, when needing to send an uplink data packet, the UE accordingly searches for a filter corresponding to the data packet, and if the filter has the foregoing small data packet indication information, the UE continues to perform 705; otherwise, transmission is performed in a common bearer manner.

705: The UE sends the small data packet to the MME by using an NAS message.

706: The MME sends the small data packet to the MTC-IWF.

707: The MTC-IWF sends the small data packet to the MTC server.

### Embodiment 6

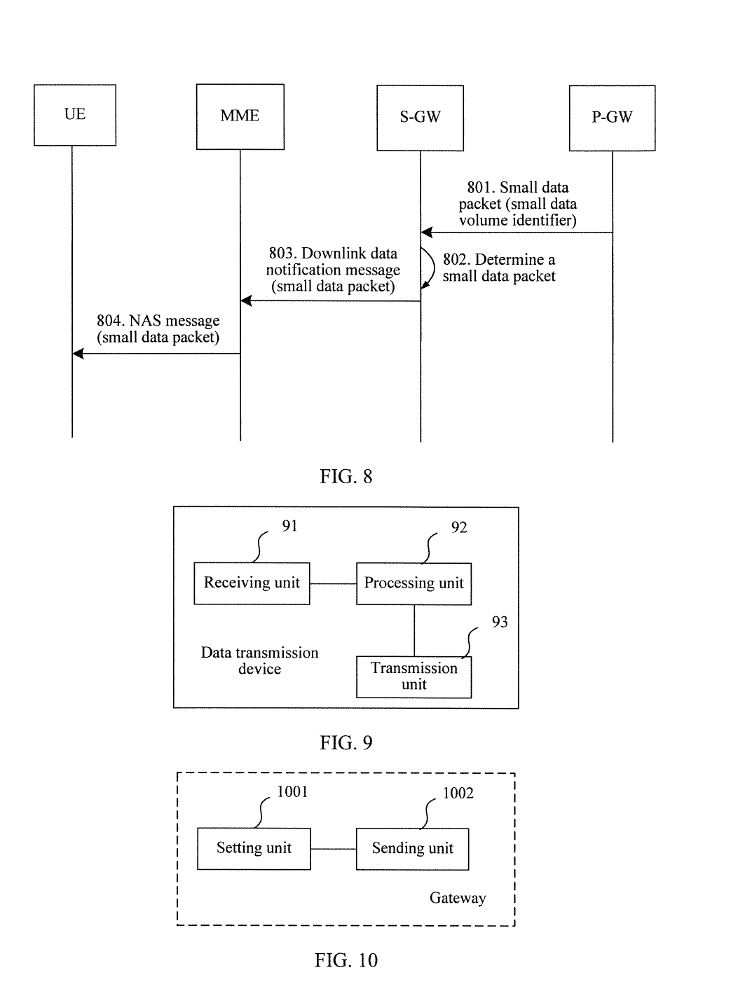

In the above embodiments, uplink data transmission is used as an example. In this embodiment, downlink data transmission is used as an example. In this embodiment, a gateway is a packet data network gateway P-GW, and a data transmission device is a serving gateway S-GW; and sending a small data packet to a mobility management entity in a control plane transmission manner, in this embodiment, is specifically: sending, by an S-GW, a small data packet to an MME by using a downlink data notification message. FIG. 8 is a schematic signaling diagram of still another embodiment of a method for transmitting a small data packet according to the present invention. As shown in FIG. 8, the method may include:

801: A P-GW sends a downlink data packet to an S-GW and sets a small data volume identifier.

When sending the downlink data packet, the P-GW adds small data packet indication information to a GTP-U header of the data packet, indicating that the data packet is a small data packet.

802: The S-GW determines a small data packet according to the small data packet indication information.

After receiving the data packet, the S-GW determines, according to the small data packet indication information set in the GTP-U header, that a small data packet is received, and therefore, continues to perform 803.

803: The S-GW adds the small data packet to a downlink data notification message of control plane signaling and sends the downlink data notification message to an MME.

In this embodiment, after determining, according to the small data packet indication information set in the GTP-U header, that a small data packet is received, the S-GW performs transmission by using a downlink data notification message, and therefore, a small data packet is relatively accurately determined, avoiding an MME signaling load increase caused by inaccurate determining of a type of a data packet.

804: The MME sends the small data packet to UE by using an NAS message.

In this step, the MME directly adds, to the NAS message, the small data packet acquired from the downlink data notification message, and sends NAS message to the UE.

### Embodiment 7

FIG. 9 is a schematic structural diagram of an embodiment of a data transmission device according to the present invention, and the device may perform a method according to any embodiment of the present invention. As shown in FIG. 9, the device may include: a receiving unit 91, a processing unit 92, and a transmission unit 93, where

the receiving unit 91 is configured to receive small data packet indication information sent by a gateway;

the processing unit 92 is configured to determine, according to the small data packet indication information received by the receiving unit, whether a to-be-sent data packet is a small data packet;

and the transmission unit 93 is configured to: when the processing unit determines that the to-be-sent data packet is a small data packet, transmit the small data packet in a control plane transmission manner.

Further, the data transmission device is user equipment UE; and the transmission unit 93 is specifically configured to send the small data packet to a mobility management entity by using a non-access stratum NAS message.

Further, the receiving unit 91 is specifically configured to receive a traffic filter template TFT sent by a packet data network gateway P-GW, where the TFT includes a data packet filter corresponding to a small data packet, and small data packet indication information is set for the data packet filter; and

the processing unit 92 is specifically configured to search for a data packet filter corresponding to the to-be-sent data packet, and if the small data packet indication information is set for the data packet filter, determine that the to-be-sent data packet is a small data packet.

Further, the receiving unit 91 is specifically configured to receive a traffic filter template TFT and small data packet indication information that are sent by a P-GW, where the TFT includes only a data packet filter corresponding to a small data packet, and the small data packet indication info nation is used for indicating that a bearer corresponding to the TFT is a bearer specially used for transmitting a small data packet; and

the processing unit 92 is specifically configured to: search for a data packet filter corresponding to the to-be-sent data packet, check whether a bearer corresponding to a TFT using the data packet filter is a bearer specially used for transmitting a small data packet, and if yes, determine that the to-be-sent data packet is a small data packet.

Further, the receiving unit 91 is specifically configured to receive a data packet filter, which is sent by a machine type communications-interworking function entity MTC-IWF, of a small data packet, where the data packet filter has small data packet indication information; and

the processing unit 92 is specifically configured to search for a data packet filter corresponding to the to-be-sent data packet, and if the data packet filter has the small data packet indication information, determine that the to-be-sent data packet is a small data packet.

Further, the small data packet indication information received by the receiving unit 91 includes a small data volume identifier extended in a data packet filter, or a filter name corresponding to a data packet filter of a small data packet.

Further, the data transmission device is a serving gateway S-GW; and the transmission unit 93 is specifically configured to send the small data packet to a mobility management entity by using a downlink data notification message.

Further, the receiving unit 91 is specifically configured to receive a to-be-sent data packet transmitted by a P-GW, where the small data packet indication information is set for a header of the data packet; and

the processing unit 92 is specifically configured to determine, according to the small data packet indication information, that the to-be-sent data packet is a small data packet.

### Embodiment 8

FIG. 10 is a schematic structural diagram of an embodiment of a gateway according to the present invention, and the gateway may perform a method according to any embodiment of the present invention. As shown in FIG. 10, the gateway may include a setting unit 1001 and a sending unit 1002, where

the setting unit 1001 is configured to set small data packet indication information; and

the sending unit 1002 is configured to send the small data packet indication information to a data transmission device, so that when determining, according to the small data packet indication information, that a to-be-sent data packet is a small data packet, the data transmission device transmits the small data packet in a control plane transmission manner.

Further, the gateway is a packet data network gateway P-GW, and the data transmission device is user equipment UE.

The setting unit 1001 is specifically configured to add a data packet filter corresponding to a small data packet to a traffic filter template TFT, and set small data packet indication information for the data packet filter.

Further, the setting unit 1001 is specifically configured to put data packet filters of small data packets into a same traffic filter template TFT, and set small data packet indication information, where the small data packet indication information is used for indicating that a bearer corresponding to the TFT is a bearer specially used for transmitting a small data packet.

Further, the sending unit 1002 is specifically configured to add the traffic filter template TFT and the small data packet indication information to create or modify bearer signaling request.

Further, the setting unit 1001 is further configured to: before the small data packet indication information is set, receive a PCC rule sent by a PCRF, where the PCC rule includes a data packet filter corresponding to a small data packet and small data packet indication information corresponding to the data packet filter, and the small data packet indication information is used by the P-GW to accordingly set the small data packet indication information; or the P-GW acquires a local configuration policy, where the local configuration policy is used by the P-GW for setting the small data packet indication information.

Further, the gateway is a machine type communications-interworking function entity MTC-IWF, and the data transmission device is user equipment UE.

The setting unit 1001 is specifically configured to acquire a data packet filter corresponding to a small data packet, where the data packet filter has small data packet indication information, and the small data packet indication information includes a small data volume identifier extended in a data packet filter, or a filter name corresponding to a data packet filter of a small data packet.

Further, the setting unit 1001 is further configured to adjust the data packet filter according to a carrier policy.

Further, the gateway is a packet data network gateway P-GW, and the data transmission device is a serving gateway S-GW.

Further, the setting unit 1001 is specifically configured set the small data packet indication information in a header of the small data packet sent to the S-GW.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A method for transmitting a small data packet, the method comprising:
receiving, by a data transmission device, small data packet indication information sent by a gateway; and
if the data transmission device determines, according to the small data packet indication information, that a to-be-sent data packet is a small data packet, transmitting, by the data transmission device, the small data packet in a control plane transmission manner.

2. The method according to claim 1, wherein:
the data transmission device is user equipment (UE); and
transmitting the small data packet in a control plane transmission manner comprises:
sending, by the UE, the small data packet to a mobility management entity by using a non-access stratum (NAS) message.

3. The method according to claim 2, wherein:
receiving, by a data transmission device, small data packet indication information sent by a gateway comprises:
receiving, by the UE, a traffic filter template (TFT) sent by a packet data network gateway (P-GW), wherein the TFT comprises a data packet filter corresponding to a small data packet, and small data packet indication information is set for the data packet filter; and
determining, by the data transmission device according to the small data packet indication information, that a to-be-sent data packet is a small data packet comprises:
searching, by the UE, for a data packet filter corresponding to the to-be-sent data packet, and if the small data packet indication information is set for the data packet filter, determining that the to-be-sent data packet is a small data packet.

4. The method according to claim 2, wherein:
receiving, by a data transmission device, small data packet indication information sent by a gateway comprises:
receiving, by the UE, a traffic filter template (TFT) and small data packet indication information that are sent by a packet data network gateway (P-GW), wherein the TFT comprises only a data packet filter corresponding to a small data packet, and the small data packet indication information is used for indicating that a bearer corresponding to the TFT is a bearer specially used for transmitting a small data packet; and
determining, by the data transmission device according to the small data packet indication information, that a to-be-sent data packet is a small data packet comprises:
searching, by the UE, for a data packet filter corresponding to the to-be-sent data packet, checking whether a bearer corresponding to a TFT using the data packet filter is a bearer specially used for transmitting a small data packet, and if yes, determining that the to-be-sent data packet is a small data packet.

5. The method according to claim 2, wherein:
receiving, by a data transmission device, small data packet indication information sent by a gateway comprises:
receiving, by the UE, a data packet filter, which is sent by a machine type communications-interworking function entity (MTC-IWF) , of a small data packet, wherein the data packet filter has small data packet indication information; and
determining, by the data transmission device according to the small data packet indication information, that a to-be-sent data packet is a small data packet comprises:
searching, by the UE, for a data packet filter corresponding to the to-be-sent data packet, and if the data packet filter has the small data packet indication information, determining that the to-be-sent data packet is a small data packet.

6. The method according to claim 3, wherein the small data packet indication information comprises a small data volume identifier extended in a data packet filter, or a filter name corresponding to a data packet filter of a small data packet.

7. The method according to claim 1, wherein:
the data transmission device is a serving gateway (S-GW); and
transmitting the small data packet in a control plane transmission manner comprises:
sending, by the S-GW, the small data packet to a mobility management entity by using a downlink data notification message.

8. The method according to claim 7, wherein:
receiving, by a data transmission device, small data packet indication information sent by a gateway comprises:
receiving, by the S-GW, a to-be-sent data packet transmitted by a packet data network gateway (P-GW), wherein small data packet indication information is set for a GTP-U header of the data packet; and
determining, by the data transmission device according to the small data packet indication information, that a to-be-sent data packet is a small data packet comprises:
determining, by the S-GW according to the small data packet indication information, that the to-be-sent data packet is a small data packet.

9. A data transmission device, comprising:
a receiver, configured to receive small data packet indication information sent by a gateway;
a processor, configured to determine, according to the small data packet indication information received by the receiver, whether a to-be-sent data packet is a small data packet; and
a transmitter, configured to: when the processor determines that the to-be-sent data packet is a small data packet, transmit the small data packet in a control plane transmission manner.

10. The device according to claim 9, wherein:
the data transmission device is user equipment (UE); and
the transmitter is configured to send the small data packet to a mobility management entity by using a non-access stratum (NAS) message.

11. The device according to claim 10, wherein:
the receiver is configured to receive a traffic filter template (TFT) sent by a packet data network gateway (P-GW), wherein the TFT comprises a data packet filter corresponding to a small data packet, and small data packet indication information is set for the data packet filter; and
the processor is configured to search for a data packet filter corresponding to the to-be-sent data packet, and if the small data packet indication information is set for the data packet filter, determine that the to-be-sent data packet is a small data packet.

12. The device according to claim 10, wherein:
the receiver is configured to receive a traffic filter template (TFT) and small data packet indication information that are sent by a packet data network gateway (P-GW), wherein the TFT comprises only a data packet filter corresponding to a small data packet, and the small data packet indication information is used for indicating that a bearer corresponding to the TFT is a bearer specially used for transmitting a small data packet; and
the processor is configured to: search for a data packet filter corresponding to the to-be-sent data packet, check whether a bearer corresponding to a TFT using the data packet filter is a bearer specially used for transmitting a small data packet, and if yes, determine that the to-be-sent data packet is a small data packet.

13. The device according to claim 10, wherein:
the receiver is configured to receive a data packet filter, which is sent by a machine type communications-interworking function entity (MTC-IWF), of a small data packet, wherein the data packet filter has small data packet indication information; and
the processor is configured to search for a data packet filter corresponding to the to-be-sent data packet, and if the data packet filter has the small data packet indication information, determine that the to-be-sent data packet is a small data packet.

14. The device according to claim 13, wherein the small data packet indication information received by the receiver comprises a small data volume identifier extended in a data packet filter, or a filter name corresponding to a data packet filter of a small data packet.

15. The device according to claim 9, wherein:
the data transmission device is a serving gateway (S-GW); and
the transmitter is configured to send the small data packet to a mobility management entity by using a downlink data notification message.

16. The device according to claim 15, wherein:
the receiver is configured to receive a to-be-sent data packet transmitted by a packet data network gateway (P-GW), wherein the small data packet indication information is set for a header of the data packet; and
the processor is configured to determine, according to the small data packet indication information, that the to-be-sent data packet is a small data packet.
